(19) United States
(12) Patent Application Publication
(10) Pub. No.: US 2017/0247270 A1
(43) Pub. Date: Aug. 31, 2017

(54) WATER TREATMENT METHODS

(71) Applicant: CRS INDUSTRIAL WATER TREATMENT SYSTEMS PTY LTD, Castle Hill (AU)

(72) Inventors: Aharon ARAKEL, Castle Hill (AU); Grant MOLONEY, Castle Hill (AU); Michael STARK, Castle Hill (AU); Samantha THEOBALD, Castle Hill (AU)

(73) Assignee: CRS INDUSTRIAL WATER TREATMENT SYSTEMS PTY LTD, Castle Hill (AU)

(21) Appl. No.: 15/516,384

(22) PCT Filed: Oct. 2, 2015
(86) PCT No.: PCT/AU2015/050601

§ 371 Date: Apr. 1, 2017

(30) Foreign Application Priority Data
Oct. 3, 2014 (AU) 2014903957

(51) Int. Cl. C02F 1/52; E21B 43/26; E21B 21/00

(52) U.S. Cl. CPC C02F 1/5236; E21B 21/00; E21B 43/26; C02F 2001/5218; C02F 2101/006

(57) ABSTRACT

Disclosed herein is a method for treating shale gas produced water. The method comprises adding a magnesium containing pH raising agent to the produced water, whereby a precipitate comprising magnesium hydroxide is formed; adding a source of carbonate ions to the produced water, whereby a carbonate containing precipitate is formed; and removing the precipitate to provide a treated water.

### TECHNICAL FIELD

The present invention relates to water treatment methods and, in particular, to methods for treating shale gas produced water.

### BACKGROUND ART

A large volume of water is required to perform hydraulic fracturing during the recovery of shale gas. Once this water has been used to perform hydraulic fracturing and removed from the well, it is referred to as shale gas produced water. Shale gas produced water typically contains a number of undesirable substances, and requires treatment before it can be re-used as a fracturing fluid or discharged to the environment. The substances contained in the shale gas produced water may include those added to the water for it to more effectively fracture the shale, as well as those which were already present in the shale formation. Shale gas produced water typically has high total dissolved solids (TDS) and high hardness, and contains significant amounts of heavy metals and naturally occurring radioactive material (NORM).

Methods for treating such wastewaters are known. U.S. Pat. No. 8,834,726, for example, discloses a method for treating gas well hydrofracture wastewater. In the method disclosed in U.S. Pat. No. 8,834,726, a metal-containing wastewater is contacted with a source of sulphate ions such as sulphuric acid (provided as a 50% by weight, or greater, solution) or acid mine drainage (AMD) to precipitate one or more metal sulphates. The one or more metal sulphates are removed and the remaining wastewater is then contacted with a source of carbonate ions to precipitate one or more metal carbonates. The mixture of the remaining wastewater and metal carbonates is then contacted with a source of hydroxide ions such as sodium hydroxide (provided as a 50% by weight solution) to precipitate one or more metal hydroxides. Reasonably extensive use of flocculants, pH adjusting agents and oxidants are also taught by U.S. Pat. No. 8,834,726.

As will be appreciated, the reagents disclosed in U.S. Pat. No. 8,834,726 are relatively corrosive and expensive reagents, which require extremely careful handling and storage, skilled operators, and specialised equipment. It would be advantageous to provide alternative methods for treating shale gas produced water which do not necessarily involve the use of such dangerous and expensive reagents, and which have the potential to be relatively simple and cheap.

### SUMMARY OF INVENTION

In a first aspect, the present invention provides a method for treating shale gas produced water. The method comprises:
adding a magnesium containing pH raising agent to the produced water, whereby a precipitate comprising magnesium hydroxide is formed;
adding a source of carbonate ions to the produced water, whereby a carbonate containing precipitate is formed; and
removing the precipitate to provide a treated water.

In the method of the present invention, a magnesium containing pH raising agent is used to increase the pH of the produced water to a level at which a precipitate comprising magnesium hydroxide is formed. At this pH, many of the other metal species (e.g. heavy metal species) which may be present in the produced water will be oxidised into non-soluble forms (e.g. metal hydroxides) and co-precipitate with the magnesium hydroxide. Magnesium hydroxide precipitate forms as a large gelatinous floc that has excellent flocculating and coagulating properties, and which, via a combination of crystallisation, flocculation, adsorption and coagulation, can trap many of the potential contaminants which are present in the produced water as it settles. Subsequently separating the precipitate from the liquid (e.g. by filtration or clarification) effectively removes both the magnesium hydroxide and the entrapped contaminants from the water. The inventors have found that a number of the species which are commonly present in shale gas produced water can be effectively adsorbed onto the surface of the magnesium hydroxide flocs and can therefore be removed with the magnesium hydroxide precipitate.

Advantageously, the method of the present invention enables a number of metal species and other undesirable substances to be removed from shale gas produced water in one reaction step using a magnesium containing pH raising agent. In contrast, other methods for treating shale gas produced water require a combination of agents to achieve a similar effect, for example, sodium hydroxide to increase the pH and thus cause precipitation of the metals etc. and flocculants to enable such precipitate to be removed. As will be appreciated, increasing the number of reagents required in a process generally increases the cost and complexity of the process.

In some embodiments, the magnesium containing pH raising agent may be dolime (CaO.MgO). Dolime is readily available, relatively cheap, and is easy and safe to handle. In contrast, other methods for treating shale gas produced water use more corrosive reagents such as sodium hydroxide and typically also require the use of relatively expensive flocculants.

In some embodiments, the method further comprises removing the precipitate comprising magnesium hydroxide before the source of carbonate ions is added. In such embodiments, the precipitate comprising magnesium hydroxide and the carbonate containing precipitate can be separately collected, thus providing the potential for the carbonate containing precipitate to be beneficially re-used (depending on its composition).

In some embodiments, the amount of the magnesium containing pH raising agent added to the produced water may be sufficient to cause the pH to rise to above about 9.5. Once above this pH, the formation of magnesium hydroxide as a precipitate, and the oxidation of many heavy metal species in the produced water, is favoured.

In some embodiments, the amount of the source of carbonate ions added to the produced water is sufficient to cause a substantial portion of any divalent cations in the produced water to precipitate. As would be appreciated, removing the amount of divalent cations in a water sample reduces its hardness as well as its tendency to cause scaling in downstream equipment.

In some embodiments, the source of carbonate ions is selected from the group consisting of: sodium carbonate and potassium carbonate (and mixtures thereof).

Shale gas produced water will often contain significant amounts of barium, which (in some forms) is a toxic substance. In some embodiments, the method of the present invention may further comprise adding a sulphate mineral to the produced water, whereby a barium containing precipitate is formed. In such embodiments, all (or at least a significant proportion) of the barium can be precipitated from the produced water in a separate step. Using a sulphate mineral to provide a source of sulphate ions for precipitation of barium sulphate has a number of benefits. For example, many sulphate minerals are non-toxic, readily available and relatively cheap. Furthermore, their use in a process does not necessitate the requirement for purpose built equipment capable of withstanding harsh reagents and operating conditions, as would be the case, for example, if concentrated sulphuric acid or acid mine drainage (AMD) were used as sources of sulphate ions.

In some embodiments, the sulphate mineral may be added to the produced water before the magnesium containing pH raising agent is added in order to precipitate the barium sulphate in a preliminary step. In some embodiments, the method further comprises removing the barium containing precipitate before the magnesium containing pH raising agent is added so that the barium is removed separately from the subsequent precipitates. As such, the volume of barium containing waste product requiring disposal would be minimised.

In some embodiments, the sulphate mineral is a calcium sulphate mineral. In some embodiments, the sulphate mineral is bassanite, gypsum or a combination thereof.

In some embodiments, the method of the present invention may further comprise processing the treated water to obtain a vendible product (e.g. sodium chloride).

In a second aspect, the present invention provides a method for treating shale gas produced water. The method comprises:
adding a sulphate mineral to the produced water, whereby a barium containing precipitate is formed;
adding a magnesium containing pH raising agent to the produced water, whereby a precipitate comprising magnesium hydroxide is formed;
adding a source of carbonate ions to the produced water, whereby a carbonate containing precipitate is formed; and
removing the precipitate to provide a treated water.

In a third aspect, the present invention provides a method for treating shale gas produced water. The method comprises:
adding a sulphate mineral to the produced water and removing a subsequently formed barium containing precipitate to provide a partially treated water;
adding a magnesium containing pH raising agent to the partially treated water, whereby a precipitate comprising magnesium hydroxide is formed;
adding a source of carbonate ions to the partially treated water, whereby a carbonate containing precipitate is formed; and
removing the precipitate to provide a treated water.

In a fourth aspect, the present invention provides a method for treating shale gas produced water. The method comprises:
adding a sulphate mineral to the produced water and removing a subsequently formed barium containing precipitate to provide a first partially treated water;
adding a magnesium containing pH raising agent to the first partially treated water and removing a subsequently formed precipitate comprising magnesium hydroxide to provide a second partially treated water;
adding a source of carbonate ions to the second partially treated water, whereby a carbonate containing precipitate is formed; and
removing the carbonate containing precipitate to provide a treated water.

The sulphate mineral, magnesium containing pH raising agent and source of carbonate ions used in the methods of the second, third and fourth aspects of the present invention may be those herein described with respect to the method of the first aspect of the present invention.

In a fifth aspect, the present invention provides a shale gas produced water which has been treated by the method of the first, second, third or fourth aspect of the present invention.

In a sixth aspect, the present invention provides the use of a shale gas produced water which has been treated by the method of the first, second, third or fourth aspect of the present invention as a drilling fluid.

In a seventh aspect, the present invention provides the use of a shale gas produced water which has been treated by the method of the first, second, third or fourth aspect of the present invention as a fracturing fluid.

### BRIEF DESCRIPTION OF THE DRAWING

Specific embodiments of the present invention will be described below, by way of example only, with reference to the following drawing, in which:

FIG. 1 is a graph depicting the concentrations of key ions in a sample of synthetic shale gas produced water following each of the reaction stages of a method in accordance with an embodiment of the present invention.

### DESCRIPTION OF EMBODIMENTS

The present invention relates generally to methods for treating shale gas produced water, as well as other waters and wastewaters having a similar composition (e.g. wastewaters from metal processing plants). Shale gas produced waters typically include the water based fracturing fluid that was injected into the well (typically referred to as flowback water), as well as any natural formation water that may have been present in the well. In the context of the present invention, the phrase “Shale gas produced water” is intended to encompass all such wastes (i.e. flowback water and natural formation water). The composition of shale gas produced water will vary, but typically includes significant amounts of toxic species such as barium, and scale forming species such as silica, calcium, iron, magnesium and strontium. The composition of shale gas produced water may also contain smaller amounts of other heavy metals and naturally occurring radioactive material. The total dissolved solids (TDS) of shale gas produced water can vary significantly, for example, from less than about 5,000 ppm TDS up to about 200,000 ppm TDS (or even higher). Shale gas produced waters may also contain non-dissolved substances such as sand and oil. As would be appreciated, shale gas produced water requires treatment to remove a number of these potential contaminants before it can be reused, either in the mining process or elsewhere.

Although the present invention will be described below in the context of treating shale gas produced water (generally referred to herein on occasions as “produced water”), it will be appreciated that it is equally applicable to treating other waters and wastewaters having a similar composition to shale gas produced water.

The present invention provides a method for treating shale gas produced water. The method comprises:
adding a magnesium containing pH raising agent to the produced water, whereby a precipitate comprising magnesium hydroxide is formed;
adding a source of carbonate ions to the produced water, whereby a carbonate containing precipitate is formed; and
removing the precipitate to provide a treated water.

The treated water produced by the method of the present invention will be reduced in at least barium, strontium, calcium, magnesium and heavy metal content. Whilst the total dissolved solids (TDS) of the treated water would typically not be appreciably different to that of the produced water, the types of ions present in the treated water will not be toxic (e.g. barium) or those which have a tendency to cause scale formation in downstream equipment (e.g. magnesium and calcium). In some embodiments, removing these ions will enable the treated water to be reused in the mining process, for example as a drilling fluid or as a fracturing fluid, or in applications outside of the mining process.

In some embodiments, the water treated in accordance with the present invention may undergo a subsequent treatment in order to enable it to be beneficially re-used in some applications (e.g. especially those outside of the shale gas operation). For example, the treated water may be subjected to reverse osmosis to reduce its TDS levels such that the RO water can be returned to the environment, used for irrigation or even made potable.

In some embodiments, the produced water treated in accordance with the present invention may need to be pre-processed to remove contaminants (such as sand and oils) which might affect the efficiency of the method of the present invention. For example, immediately after its removal from the well, the produced water may be allowed to stand for a period of time to allow any relatively large particulate matter (e.g. sand) to sink. It may also be beneficial if the produced water was pre-concentrated (e.g. by evaporation (e.g. solar or thermal), membrane distillation, reverse osmosis, forward osmosis, etc.) before treatment to reduce the volume of produced water to be treated. It may also be possible to remove clean water from the produced water in a preliminary step (i.e. while the contaminants are relatively dilute), with the remaining water being the produced water to be treated in accordance with the present invention. Such clean water could, for example, be the permeate from the reverse osmosis or distillate from the evaporation step discussed above.

In some embodiments, the method of the present invention may further comprise processing the treated water to obtain a vendible product. Vendible products which might be obtained from water treated in accordance with the present invention may include, for example, sodium chloride, calcium carbonate, barium sulphate, as well as the treated water itself (e.g. if the treated water is potable or useable for irrigation, etc.).

The method of the present invention comprises adding a magnesium containing pH raising agent to the produced water, whereby a precipitate comprising magnesium hydroxide is formed. Any agent which contains a source of magnesium ions (i.e. which contains magnesium and at least partially disassociates upon exposure to the produced water) and which is capable of increasing the pH of the produced water to a value at which a precipitate comprising magnesium hydroxide may be formed can be used in the present invention. It is within the ability of a person skilled in the art to select suitable magnesium containing pH raising agents in light of the teachings herein, and routine experiments would demonstrate their suitability for use in the present invention.

Specific magnesium containing pH raising agents include dolime (CaO.MgO), magnesium oxide (MgO) and magnesium hydroxide (Mg(OH)₂). Dolime undergoes a process called slaking, where it becomes hydrated when contacted with water and dissociates into its ion forms and hence dissolves into the produced water to produce Ca²⁺, Mg²⁺ and OH⁻, which increases the pH. Similarly, magnesium oxide and magnesium hydroxide dissociate in the produced water to increase the pH and produce Mg²⁺ and OH⁻.

As noted above, raising the pH of the produced water to a level at which a precipitate comprising magnesium hydroxide is formed causes many of the other metal species which may be present in the produced water to be oxidised into non-soluble forms (e.g. metal hydroxides) and thus co-precipitate with the magnesium hydroxide. Magnesium hydroxide precipitate forms as a large gelatinous floc that can trap many of the contaminants which are present in the produced water as it settles. Separating the precipitate comprising magnesium hydroxide and any entrapped co-precipitate or other contaminants from the treated produced water effectively removes them from the water, without requiring the addition of additional (potentially expensive) flocculating agents.

Dolime is expected to be a more effective magnesium containing pH raising agent than magnesium oxide or magnesium hydroxide when treating many kinds of produced water because of its extra source of hydroxide ions from the CaO portion. Dolime allows the hydroxide ions from the CaO portion to be utilised in oxidising any magnesium and heavy metals present, while the MgO portion can form magnesium hydroxide, with its attendant benefits. However, magnesium oxide and magnesium hydroxide will achieve a similar result, albeit at the expense of “leaking” some magnesium ions into the water (which may need to be “mopped up”, for example, in the carbonate precipitation step).

As they slowly dissolute, the use of reagents such as dolime enables safer handling conditions and a process that is more immune to over dosing because excess reagent will not dissolve into solution and hence not potentially create large process disruptions. Any excess reagent that is not dissolved into the process water would be removed with the precipitate comprising magnesium hydroxide.

Adding the magnesium containing pH raising agent to the produced water results in the formation of a precipitate comprising magnesium hydroxide. Magnesium hydroxide precipitates will typically only form once the pH of the produced water has risen to above about 8.5. Furthermore, a pH below about 8.5 may not be sufficient to cause significant oxidisation of the other metal species in the produced water. Typically, the amount of the magnesium containing pH raising agent added is therefore the amount sufficient to cause the pH to rise to above about 8.5. As would be appreciated, increasing the amount of the magnesium containing pH raising agent added to the produced water to further increase the pH will result in a more complete oxidation of the other metal species in the produced water, and the formation of a greater amount of magnesium hydroxide precipitate. However, if the pH of the produced water is caused to rise above about 12, then the process would start to become less cost-effective and (depending on the desired outcome of the treatment method) the benefits of increased oxidation/precipitate formation may be offset by the increasing reagent costs. Furthermore, adding too much calcium (if dolime is used) to the water may result in excess calcium in the solution, which may need to be subsequently removed (e.g. in the carbonate precipitation step).

The amount of the magnesium containing pH raising agent added to the produced water will therefore depend on factors such as the composition of the produced water, the intended purpose of the treated water, the specific magnesium containing pH raising agent being used and the relative costs of the reagents. It is within the ability of a person skilled in the art to take all of the relevant factors into consideration and, in light of the teachings herein, devise an appropriate dosing strategy.

In some embodiments, the amount of the magnesium containing pH raising agent added to the produced water is the amount sufficient to cause the pH to rise to above about 9. In some embodiments, the amount of the magnesium containing pH raising agent added to the produced water is the amount sufficient to cause the pH to rise to above about 9.5. In some embodiments, the amount of the magnesium containing pH raising agent added to the produced water is the amount sufficient to cause the pH to rise to above about 10. In some embodiments, the amount of the magnesium containing pH raising agent added to the produced water is the amount sufficient to cause the pH to rise to above about 10.5. In some embodiments, the amount of the magnesium containing pH raising agent added to the produced water is the amount sufficient to cause the pH to rise to above about 11.

Whilst the amount of the magnesium containing pH raising agent actually required will depend on factors such as the composition and volume of the produced water, the intended use of the treated water, and the magnesium containing pH raising agent being used, between about 1 mg/mL and 10 mg/mL of the magnesium containing pH raising agent would typically be added to the produced water to cause formation of a precipitate comprising magnesium hydroxide. For example, the amount of the magnesium containing pH raising agent added to the produced water may be between about 2 mg/mL and 8 mg/mL, 3 mg/mL and 7 mg/mL, 4 mg/mL and 8 mg/mL or 3 mg/mL and 10 mg/mL. The amount of the magnesium containing pH raising agent added to the produced water may, for example, be about 1 mg/mL, 2 mg/mL, 3 mg/mL, 4 mg/mL, 5 mg/mL, 6 mg/mL, 7 mg/mL, 8 mg/mL, 9 mg/mL or 10 mg/mL.

The amount of the magnesium containing pH raising agent to be added to the produced water could also be calculated based on the amount of magnesium and heavy metals in the produced water. The amount of magnesium and heavy metals in the produced water can be measured and/or calculated using techniques known in the art, and the required amount of the magnesium containing precipitate readily calculated using stoichiometric ratios once this information was available. In some embodiments, it may be advantageous to “overdose” the magnesium containing pH raising reagent to increase removal efficiency as the hydration process/slaking can sometimes take a long time to complete. As noted above, excess (undissolved) reagent can be removed with the precipitate.

The magnesium containing pH raising agent may be added to the produced water using any conventional technique or combinations of such techniques. For example, the magnesium containing pH raising agent may be added to a vessel containing the produced water in powder form with vigorous stirring. Alternatively, the magnesium containing pH raising agent may be added to a liquid, and the resultant solution or slurry mixed into the produced water.

The method of the present invention also comprises adding a source of carbonate ions to the produced water, whereby a carbonate containing precipitate is formed. Given the nature of shale gas produced water, the carbonate containing precipitate will usually include the carbonates of divalent metals, and this step is used to “mop up” divalent cations in the produced water. Any agent which contains a source of carbonate ions can be used in the present invention. It is within the ability of a person skilled in the art to select a suitable source of carbonate ions in light of the teachings herein, and routine experiments would demonstrate its suitability for use in the present invention.

Typically, the source of carbonate ions is an agent containing a carbonate anion. Typically, the cation in such an agent is one that would be expected to be present in shale gas produced water, such that addition of the source of carbonate ions does not introduce a new species into the produced water. Typically, the cation in such an agent is one that would not subsequently need to be removed. Sodium and potassium, for example, are suitable cations. Accordingly, in some embodiments, the source of carbonate ions is selected from the group consisting of sodium carbonate, potassium carbonate and mixtures thereof.

In some embodiments, however, the source of carbonate ions need not be an agent containing a carbonate anion, provided that that agent would react to provide (or otherwise be capable of delivering) a carbonate ion upon addition to the produced water. It is envisaged, for example, that, under some conditions, bicarbonate-containing salts may be suitable for use in the method of the present invention.

The source of carbonate ions may be added to the produced water in any suitable form. For example, the source of carbonate ions may be added to the produced water in a powder form, or in a pre-mixed form, such as a pre-mixed slurry or solution. As there can often be material handling issues associated with the delivery of powder forms of reagents, the addition of the source of carbonate ions in the form of a slurry or solution (whether the source of carbonate ions dissolves will depend on its solubility and the pre-mixing time) would usually be preferred.

The amount of the source of carbonate ions added to the produced water will depend on factors such as the amount of the contaminant(s) in the produced water to be precipitated with the carbonate containing precipitate, and the permissible upper limit of that contaminant (or those contaminants) in the treated water. Typically, the amount of the source of carbonate ions added to the produced water will depend on factors such as the amount of divalent cations in the produced water and the permissible upper limit of divalent cation concentrations in the treated water (e.g. treated water for re-use in shale gas mining processes could probably contain a higher amount of divalent cations than could, for example, treated water intended to be potable).

In some embodiments, the amount of the source of carbonate ions added to the produced water is sufficient to cause a substantial portion of any divalent cations in the produced water to precipitate. A “substantial portion”, in this context will depend on factors such as those discussed above. However, in some embodiments, causing a “substantial portion” of the divalent cations remaining in the produced water to precipitate causes more than about 50% of the divalent cations remaining in the produced water to precipitate. In some embodiments, causing a “substantial portion” of the divalent cations remaining in the produced water to precipitate causes more than about 55%, 60%, 65%, 70% or 75% of the divalent cations remaining in the produced water to precipitate.

In some embodiments, the amount of the source of carbonate ions added to the produced water is sufficient to cause substantially all of the divalent cations remaining in the produced water to precipitate. In this context, “substantially all” will depend on factors such as those discussed above. As would be appreciated, “substantially all”, in this context, does not preclude a small proportion of the divalent cations remaining in the water and not forming part of the precipitate. In some embodiments, causing “substantially all” of the divalent cations remaining in the produced water to precipitate causes more than 80% of the divalent cations remaining in the produced water to precipitate. In some embodiments, causing “substantially all” of the divalent cations remaining in the produced water to precipitate causes more than 85%, 90%, 95%, 96%, 97%, 98% or 99% of the divalent cations remaining in the produced water to precipitate.

As will be appreciated, the proportion or amount of the divalent cations (and indeed, all other contaminants in the produced water) removed in accordance with the present invention will depend on factors such as the composition of the produced water and the intended use of the treated water. It is within the ability of a person skilled in the art in light of the teachings herein to determine an appropriate amount of any particular contaminant to be removed based on the amount initially contained in the produced water and the amount allowed to be contained in the treated water. For example, a discharge hardness of less than 2,500 mg/L (as CaCO₃) is typically required before a treated water can be reused as a hydrofracture fluid. The levels of other potential contaminants in the produced and treated waters can similarly be determined by reference to appropriate guidelines or regulations.

The steps of the present invention are typically performed in the order in which they are described above (i.e. by adding the magnesium containing pH raising agent and subsequently adding the source of carbonate ions). In some embodiments, it may be desirable to treat certain shale gas produced waters by adding the source of carbonate ions to the produced water and subsequently adding the magnesium containing pH raising agent. However, as the carbonate precipitation is typically intended to “mop up” any divalent cations (including calcium and magnesium) in the partially treated produced water, complete removal of all possible contaminants might be difficult to achieve in such embodiments. In some embodiments, it may also be possible to treat certain shale gas produced waters by adding a source of carbonate ions and magnesium containing pH raising agent to the produced water at the same time. Again, however, the reactions and dosing regimens might be more difficult to optimise in such embodiments.

The method of the present invention also comprises removing the precipitate to provide a treated water. The precipitate may be in the form of a combined precipitate comprising magnesium hydroxide and carbonate containing precipitate for removal together at the end of the method. Alternatively, if it would be advantageous to keep the precipitates separate, the precipitate comprising magnesium hydroxide may be removed before the source of carbonate ions is added to the (partially treated) produced water (or vice versa). It may, for example, be advantageous to keep these precipitates separate if the carbonate containing precipitate might be able to be put to a beneficial use. For example, in some embodiments, the carbonate containing precipitate may include primarily a vendible product such as calcium carbonate, and selling such a product may help to offset costs associated with the treatment process.

Given the contaminants that will likely be associated with the precipitate comprising magnesium hydroxide, it is unlikely (although possible) that this precipitate would be a vendible product. However, it may be advantageous to collect this precipitate separately in situations where any of the species contained within the precipitate may be classified as toxic or radioactive materials and require a more specialised (i.e. expensive) disposal.

The combined precipitate comprising magnesium hydroxide and carbonate containing precipitate or the separate precipitate comprising magnesium hydroxide and carbonate containing precipitate may be removed from the (partially treated) produced water using any suitable technique. Examples of techniques which might be employed to separate the precipitate(s) from the water include filtration and clarification. The choice between these techniques (and other suitable techniques) would depend on a number of factors including the volume and composition of the treated water, as well as the intended use(s) for the precipitates.

The method of the present invention may further comprise adding a sulphate mineral to the produced water, whereby a barium containing precipitate is formed. As noted above, shale gas produced water will often contain significant amounts of barium, which (in some forms) is a toxic substance. It can therefore be advantageous to remove substantially all (or at least a significant proportion) of the barium from the produced water in a separate step. As would be appreciated, “substantially all”, in this context, does not preclude a small proportion of the barium ions remaining in the treated water and not forming part of the resultant barium containing precipitate.

In embodiments of the present invention not involving the addition of a sulphate mineral, any barium in the produced water would precipitate as barium carbonate following addition of the source of carbonate ions to the produced water. However, the barium carbonate would contaminate the carbonate containing precipitate, potentially resulting in a greater volume of waste material needing to be processed in accordance with more stringent requirements.

When required, any suitable sulphate mineral may be used in the method of the present invention, provided it is capable of providing a source of sulphate ions once added to the produced water. One class of sulphate minerals which may be used are calcium sulphate minerals because the calcium ions are unlikely to contaminate the produced water (which will almost certainly contain high amounts of calcium ions) and would usually be removed as calcium carbonate in the carbonate containing precipitate (assuming this step was performed subsequent to the barium precipitation step in the method of the present invention). Examples of sulphate minerals include bassanite (CaSO₄.½H₂O), gypsum (CaSO₄.2H₂O), magnesium sulphate (kieserite, epsomite), sodium sulphate (mirabilite, thenardite), potassium sulphate and some combinations (e.g. kainite, schonite).

Bassanite and gypsum (which are often found in combination) are especially useful sulphate minerals for use in the method of the present invention because they slowly disassociate when added to the produced water (and hence have the benefits associated with slow dissolution as discussed above) to provide sulphate ions. Bassanite and gypsum are also non-toxic, readily available and relatively cheap.

In some embodiments, a single sulphate mineral may be added to the produced water in order to cause formation of the barium containing precipitate. In some embodiments, a combination of sulphate minerals may be used, for example, in order to take advantage of beneficial properties of each of the sulphate minerals.

Any effective amount of the sulphate mineral may be added to the produced water. The amount added would typically be calculated (e.g. stoichiometrically) to ensure that substantially all of the barium would be caused to precipitate and hence be removable from the produced water (although it may be appropriate if only a significant proportion of the barium is removed in some embodiments). Initial dosing of the sulphate mineral may, for example, be based on a water quality analysis with the amount required being calculable from the analysis. After that, online monitoring of sulphate (e.g. using an awa CL822 sulphate colorimetric online analyser) could be used to keep sulphate at a small excess in the partially treated water exiting the reaction vessel in which precipitation of the barium containing precipitate had occurred.

When required, the sulphate mineral may be added to the produced water in any suitable form. For example, the sulphate mineral may be added to the produced water in a powder form, or in a pre-mixed form, such as a pre-mixed slurry or solution. As there can often be material handling issues associated with the delivery of powder forms of reagents, addition of the sulphate mineral in the form of a slurry or solution (whether the sulphate mineral dissolves will depend on its solubility and the pre-mixing time) would usually be preferred.

The sulphate mineral may be added to the produced water at any stage, but would typically added before the magnesium containing pH raising agent is added. Furthermore, whilst the barium containing precipitate may be removed at any time (e.g. at the same time as the precipitate comprising magnesium hydroxide and carbonate containing precipitate), it would typically be removed before the magnesium containing pH raising agent was added so that the volume of potentially toxic barium containing waste is minimised.

In some embodiments, the method of the present invention may further comprise testing the produced water to determine an amount of metal ions (and possibly other contaminants) contained therein. Whilst constant dosage of the reagents used in the present invention based on an average calculation of the properties of “typical” shale gas produced water may be appropriate in some circumstances, it would usually be preferable to continually monitor these properties in order to reduce the amount of reagents used (and hence decrease cost) in the event that they are being overdosed, and ensure that the treated water has consistent properties (i.e. notwithstanding that the properties of the shale gas produced water may have varied significantly).

Testing of the produced water to determine an amount of metal ions contained therein may be conducted using known instruments, such as a HACH APA6000 High Range Hardness Analyser, which measures the total hardness of the sample. Such equipment is capable of detecting the presence of and measuring a quantity of many metal ions, but the ones of most interest to the method of the present invention include barium, calcium, magnesium, strontium, manganese, radium and lithium. The produced water may be tested (e.g. for its total hardness) before, during and/or after the method of the present invention. As the properties of shale gas produced water may vary significantly (even from the same well), it may be beneficial to continually test the produced water such that the dosage of reagents can be optimised to further reduce operating costs.

It will be appreciated that in embodiments of the present invention where two (or more) steps are required, these steps do not necessarily need to be performed immediately after one another, at the same location, or by the same operator. For example, in some embodiments, the production and separation of the barium containing precipitate from the produced water could be performed in a first plant (e.g. one certified to handle toxic reagents) and the partially treated water could be processed to recover the other precipitates in a second plant. Further, in some embodiments of the present invention involving two (or more) steps, the order of the steps may be altered in order to optimise the overall method.

In a more specific form, the present invention provides a method for treating shale gas produced water, comprising:
adding a sulphate mineral to the produced water, whereby a barium containing precipitate is formed;
adding a magnesium containing pH raising agent to the produced water, whereby a precipitate comprising magnesium hydroxide is formed;
adding a source of carbonate ions to the produced water, whereby a carbonate containing precipitate is formed; and
separating the precipitate from a treated water.

In a yet more specific form, the present invention provides a method for treating shale gas produced water, comprising:
adding a sulphate mineral to the produced water and removing a subsequently formed barium containing precipitate to provide a partially treated water;
adding a magnesium containing pH raising agent to the partially treated water, whereby a precipitate comprising magnesium hydroxide is formed;
adding a source of carbonate ions to the partially treated water, whereby a carbonate containing precipitate is formed; and
separating the precipitate from a treated water.

In a yet more specific form, the present invention provides a method for treating shale gas produced water, comprising:
adding a sulphate mineral to the produced water and removing a subsequently formed barium containing precipitate to provide a first partially treated water;
adding a magnesium containing pH raising agent to the first partially treated water and removing a subsequently formed precipitate comprising magnesium hydroxide to provide a second partially treated water;
adding a source of carbonate ions to the second partially treated water, whereby a carbonate containing precipitate is formed; and
separating the carbonate containing precipitate to provide a treated water.

Also provided by the present invention are shale gas produced waters which have been treated in accordance with the methods of the present invention, and uses of shale gas produced waters which have been treated in accordance with the methods of the present invention. Potential uses of such treated shale gas produced water include as a drilling fluid or a fracturing fluid or, possibly after further treatment involving procedures for reducing the amount of TDS, as irrigation water or even potable water. Such treated waters may also be returned to the environment (e.g. from which they were drawn), and provide additional water resources for drought-stricken or arid areas.

### EXAMPLE

A specific embodiment of the present invention will now be described, in which a multistage precipitation/separation process is used to reduce the concentration of typical problematic constituents in shale gas produced water.

The first reaction step involves contacting the produced water with bassanite/gypsum as a sulphate ion source. The sulphate ions react with the barium present in the water and can be separated as BaSO₄ as a solid.

The second reaction step involves contacting the treated water from the first separation step with dolime as a magnesium and hydroxide ion source. The hydroxide ions raise the pH and oxidise the heavy metals and magnesium present and remove some extra impurities in the Mg(OH)₂ floc, as discussed above. The Mg(OH)₂ floc etc. can be separated as a solid.

The third reaction step involves contacting the treated water from the second separation step with sodium carbonate as a carbonate ion source. The carbonate ions react with the calcium and strontium to form insoluble products which are removed via solid liquid separation techniques, resulting in the production of a treated water.

Shale gas produced waters generally require additional treatment to remove turbidity and hydrocarbons/oil and grease that will not be removed by the specific embodiment described above, but can be performed prior to it utilising existing techniques.

A three step reaction pathway in accordance with an embodiment of the present invention and utilising three reagents to remove impurities and recover solid products was trialled to ascertain how well a synthetic shale gas produced water could be “cleaned up” for reuse in well drilling operations or otherwise.

The first reaction step utilises reactive bassanite (CaSO₄.½H₂O) and is intended to remove barium from the brine water via precipitation of barium sulphate.

CaSO₄.½H₂O+BaCl₂→BaSO₄+CaCl₂

The second reaction step employs dolime (CaO.MgO) to remove magnesium ions, again through a precipitation reaction resulting in the formation of magnesium hydroxide. Other metallic ions may also form hydroxides in this reaction step and be removed from the brine waters as a co-precipitate or by becoming caught on the magnesium hydroxide flocs.

MgCl₂+Mg(OH)₂+Ca(OH)₂→2Mg(OH)₂+CaCl₂

The third reaction step is essentially a final “clean up” step to remove at least any calcium ions from the produced water by using sodium carbonate to produce a calcium carbonate precipitate. The reaction is outlined below.

Na₂CO₃+CaCl₂→CaCO₃+2NaCl

To create a synthetic shale gas brine sample, the following amounts of compounds was combined in a 1 L volumetric flask and RO permeate water was added to make up the sample to 1 L. The sample was then mixed thoroughly. The solution was bright yellow in colour. No acid adjustment to dissolve constituents was necessary.
a. 59.431 g NaCl
b. 2.1888 g BaCl₂
c. 9.2376 g MgCl₂.6H₂O
d. 67.2150 g CaCl₂.6H₂O
e. 10.5900 g SrCl2.6H₂O
f. 0.2699 g FeCl₃
g. 1.0459 g KCl
h. 0.9080 g NaBr
i. 0.5420 g LiCl
j. 0.0606g Na₂SO₄

In a beaker, 1.5281 g of bassanite was added to 20.61 g water and mixed with a magnetic stirrer for 30 minutes at ambient temperature. This bassanite/water mixture was then added to the 1 L synthetic shale gas brine sample. The pH and the temperature of the synthetic shale gas brine sample were recorded as 2.56 and 17.1° C. respectively (this reading was taken just before the addition of the bassanite/water solution).

This shale gas brine/bassanite mixture was mixed with a magnetic stirrer for a 60 minute reaction period. The temperature, pH and appearance were recorded at 10 minute intervals for the duration of the reaction period and are shown below in Table 1.

Once the first step reaction period was complete, the mixture was passed through a vacuum filtration unit to separate the solids and liquid. 807 mL of liquid was collected from the first reaction step and carried over to perform the second reaction step.

To perform the second reaction step, 5.4762 g of dolime (calcined in-house) was added to 54.73 g of water in a beaker and stirred with a magnetic stirrer for 30 minutes at ambient temperature. This dolime/water mixture was then added to the 807 mL of liquid supernatant carried over from reaction step 1 and mixed with a magnetic stirrer for a 60 minute reaction period. The temperature, pH and appearance were recorded at 10 minute intervals for the duration of the reaction period and are shown below in Table 2.

Once the second step reaction period was complete, the mixture was passed through a vacuum filtration unit to separate the solids and liquid. 605 mL of liquid was collected from the second reaction step and carried over to perform the third and final reaction step.

To perform the third reaction step, 33.7973 g of sodium carbonate was added to 339.09 of water in a beaker and stirred with a magnetic stirrer for 30 minutes at ambient temperature. This sodium carbonate/water mixture was then added to the 605 mL of liquid supernatant carried over from reaction step 2 and mixed with a magnetic stirrer for a 60 minute reaction period. The temperature, pH and appearance were recorded at 10 minute intervals for the duration of the reaction period and are shown below in Table 3.

TABLE 1
pH, temperature and appearance of solution recorded during reaction time
of the first reaction step

| | | | Appearance of |
|---|---|---|---|
| Time (min) | pH | Temperature | Solution |
| 0 | — | — | Cloudy yellow |
| 10 | 2.62 | 17.5 | As above |
| 20 | 2.61 | 17.6 | As above |
| 30 | 2.59 | 17.8 | As above |
| 40 | 2.56 | 18.1 | As above |
| 50 | 2.54 | 18.5 | As above |
| 60 | 2.52 | 18.8 | As above |

TABLE 2
pH, temperature and appearance of solution recorded during reaction time
of the second reaction step

| | | | Appearance of |
|---|---|---|---|
| Time (min) | pH | Temperature | Solution |
| 0 | — | — | Cloudy yellow |
| 10 | 11.78 | 15.6 | As above |
| 20 | 11.77 | 16.1 | As above |
| 30 | 11.74 | 17.5 | As above |
| 40 | — | — | As above |
| 50 | 11.71 | 18.2 | As above |
| 60 | 11.69 | 18.9 | As above |

TABLE 3
pH, temperature and appearance of solution recorded during reaction time
of the third reaction step

| | | | Appearance of |
|---|---|---|---|
| Time (min) | pH | Temperature | Solution |
| 0 | 11.17 | 19.9 | milky white & thick |
| 10 | 11.28 | 19.8 | As above |
| 20 | 11.30 | 20.3 | As above |
| 30 | 11.28 | 20.9 | As above |
| 40 | 11.26 | 21.5 | As above |
| 50 | 11.23 | 22.1 | As above |
| 60 | 11.21 | 22.6 | As above |

The synthetic shale gas brine solution was initially a clear bright yellow colour. Once bassanite was added the solution turned cloudy yellow in appearance. The supernatant was slightly reduced in colour and cloudiness after filtration. The solution remained cloudy yellow through the second reaction, with the addition of dolime not resulting in any significant change in appearance or colour. Once the second reaction step was complete and filtered, the supernatant was stripped of colour and cloudiness and was clear to the eye. Once the sodium carbonate was added to the filtered supernatant from the second reaction step, the solution instantly turned thick and milky in appearance.

TABLE 4
Independent laboratory results indicating the water analysis of
the feed and after each reaction step

| Analyte Name | | Synthetic Shale | Supernatant | Supernatant | Supernatant |
|---|---|---|---|---|---|
| (mg/L) | Units | Gas Brine (Feed) | after RXN 1 | after RXN 2 | after RXN 3 |
| Chloride, Cl | mg/L | 71000 | 70000 | 65000 | 41000 |
| Sulphate, SO4 | mg/L | <20 | <20 | <20 | <10 |
| Barium, Ba | mg/L | 1300 | 480 | 450 | 0.540 |
| Iron, Fe | mg/L | 8.000 | 7.000 | <0.05 | <0.05 |
| Strontium, Sr | mg/L | 3000 | 2900 | 2700 | 2.600 |
| Calcium, Ca | mg/L | 16000 | 15000 | 17000 | 18.0 |
| Magnesium, | mg/L | 1100 | 1100 | 7.0 | 6.0 |
| Mg | | | | | |
| Potassium, K | mg/L | 740 | 710 | 680 | 440 |
| Sodium, Na | mg/L | 23000 | 21000 | 21000 | 27000 |
| Lithium, Li | mg/L | 70.0 | 70.0 | 67.0 | 26.0 |

Table 4 indicates how each reaction step performed. The synthetic shale gas brine (feed) illustrates the constituents in the initial water sample prepared. The first reaction step was intended to remove barium from the brine water via precipitation of barium sulfate. As can be seen in Table 4, the barium content was reduced after the first reaction step from 1300 mg/L to 480 mg/L, giving a conversion of 63% of the first reaction step. The slight reduction in iron and strontium content also indicates the formation of iron sulfate and strontium sulfate from the addition of bassanite in the first reaction step. This would have reduced the amount of bassanite available for the first reaction step to form barium sulfate, lowering the reaction conversion percentage. The remaining sulfate after the first reaction step was less than 20 mg/L, which was the same as in the feed, indicating that the all the sulfate ions added in the form of bassanite were used to form precipitates of barium, iron and strontium. Given these results, it is clear that the first reaction step can remove barium. However, the dosing of bassanite was too small to remove all the barium in the feed water, as indicated by the sulfate levels after reaction step 1. With an increased bassanite dosage in the first step it is possible that all the barium from the feed water will be removed. In addition, as the use of bassanite also saw the removal of some iron and strontium ions in the feed water, presumably as iron sulfate and strontium sulfate, an increase in bassanite dosage in the first reaction step may also see a further reduction in iron and strontium content.

The second reaction step was aimed at reducing the magnesium content in the water using dolime to precipitate magnesium hydroxide. As can be seen in Table 4 the magnesium content in the water dropped from 1100 mg/L to 7 mg/L after reaction step 2, indicating 99% conversion of reaction step 2. Other ions were also removed in the second reaction step. Iron was essentially completely removed reducing from 7 mg/L to less than 0.05 mg/L. Some strontium and potassium were also removed. It is likely that these species were caught up in the magnesium hydroxide floc and hence removed with the magnesium hydroxide precipitate.

The final step removed 99.9% of the calcium ions present in the water. Not only did the use of sodium carbonate in the final step remove calcium ions, it also removed most of the remaining strontium and barium ions. The strontium ion content reduced from 2700 mg/L to 2.6 mg/L; a 99.9% removal rate. The barium ion content reduced from 450 mg/L to 0.540 mg/L, also a 99.9% removal rate. In addition, the potassium and lithium ion content in the water was also reduced by 35.3% and 61.2% respectively. The sodium ion content increased after the third reaction step, owing to the addition of sodium ions via sodium carbonate.

The final analysis of the supernatant liquid after reaction step 3 indicates that it contains primarily chloride (41,000 mg/L) and sodium ions (27,000 mg/L), with potassium, lithium and calcium being the next major components at 440 mg/L, 26 mg/L and 18 mg/L, respectively. The rest of the components were below 10 mg/L. The final water after the third reaction step is relatively “clean”. Refer to Table 4 for the full water analysis.

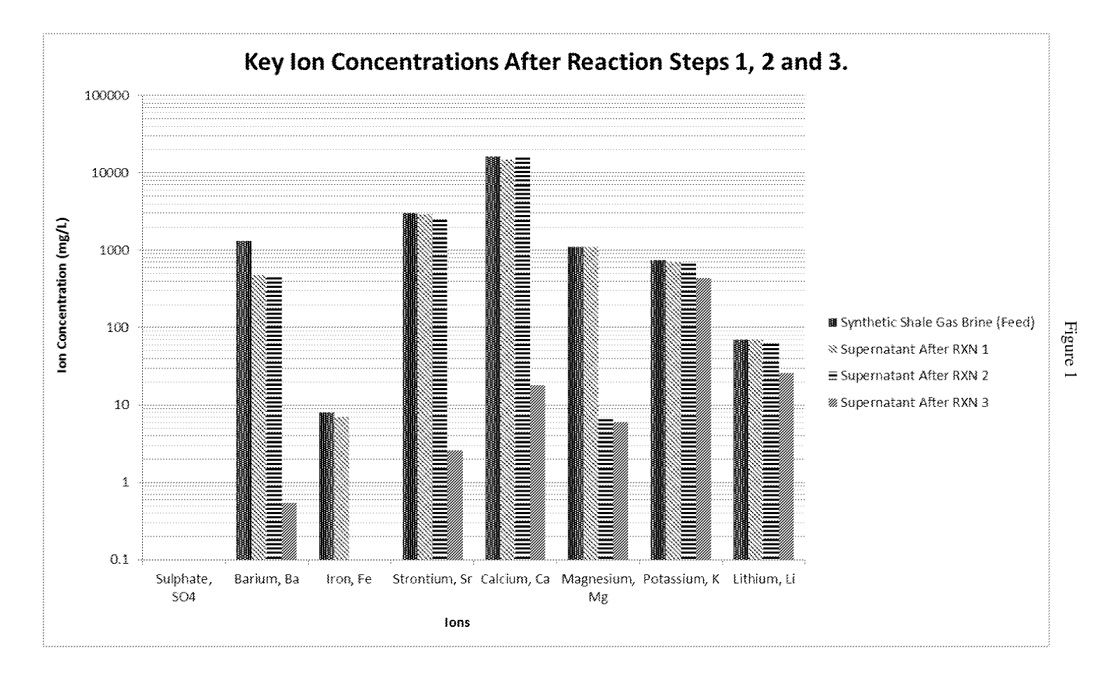

FIG. 1 graphically illustrates the key ion concentrations after reaction steps 1, 2 and 3. It can be seen that the barium ion concentration after the first reaction step has been reduced by a little more than half, while iron and strontium ion concentrations remain virtually unchanged after the first reaction step. The magnesium ion concentration after the second reaction step is negligible, indicating that the dolime dosage in the second reaction step was sufficient to remove the magnesium ions present in the water. The calcium ion concentration after the second reaction step increases as calcium ions are introduced into the system via the dolime reagent. After reaction step 3 the calcium ion concentration is negligible indicating that the sodium carbonate dosage was sufficient for essentially complete calcium ion removal.

FIG. 1 clearly shows the efficiency of the first, second and third reaction steps described above. As the focus of this trial was primarily on the key ions relating to reaction steps 1, 2 and 3 chloride and sodium concentration are not included in FIG. 1.

As will be appreciated, specific embodiments of the present invention may provide one or more of the following advantages:
treatment of shale gas produced water can be carried out without any requirement for corrosive and dangerous chemicals;
additional reagents such as flocculants are not necessarily required due to the flocculating properties of the magnesium hydroxide precipitate;
the treatment reagents are generally relatively cheap;
the treatment processes are generally relatively simple; and
a relatively small equipment footprint is required.

It will be understood to persons skilled in the art of the invention that many modifications may be made to the specific methods described above without departing from the spirit and scope of the invention, as defined in the following claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that any prior art publication referred to herein does not constitute an admission that the publication forms part of the common general knowledge in the art.

1. A method for treating shale gas produced water, comprising:
adding a magnesium containing pH raising agent to the produced water, whereby a precipitate comprising magnesium hydroxide is formed;
adding a source of carbonate ions to the produced water, whereby a carbonate containing precipitate is formed; and
removing the precipitate to provide a treated water.

2. The method of claim 1, further comprising removing the precipitate comprising magnesium hydroxide before the source of carbonate ions is added.

3. The method of claim 1, wherein the amount of the magnesium containing pH raising agent added to the produced water is sufficient to cause the pH to rise to above about 9.5.

4. The method of claim 1, wherein the magnesium containing pH raising agent comprises dolime.

5. The method of claim 1, wherein the amount of the source of carbonate ions added to the produced water is sufficient to cause a substantial portion of any divalent cations in the produced water to precipitate.

6. The method of claim 1, wherein the source of carbonate ions is selected from the group consisting of: sodium carbonate, potassium carbonate and mixtures thereof.

7. The method of claim 1, wherein the precipitate is removed by clarification.

8. The method of claim 1, further comprising adding a sulphate mineral to the produced water, whereby a barium containing precipitate is formed.

9. The method of claim 8, wherein the sulphate mineral is added to the produced water before the magnesium containing pH raising agent is added.

10. The method of claim 9, further comprising removing the barium containing precipitate before the magnesium containing pH raising agent is added.

11. The method of claim 8, wherein the sulphate mineral is a calcium sulphate mineral.

12. The method of claim 8, wherein the sulphate mineral is bassanite, gypsum or a combination thereof.

13. The method of claim 1, further comprising testing the produced water to determine an amount of metal ions contained therein.

14. The method of claim 13, wherein the metal ions are selected from one or more of the following: barium, calcium, magnesium, strontium, manganese, radium and lithium.

15. The method of claim 13, wherein the produced water is continually tested.

16. The method of claim 1, further comprising processing the treated water to obtain a vendible product.

17. A method for treating shale gas produced water, comprising:
adding a sulphate mineral to the produced water, whereby a barium containing precipitate is formed;
adding a magnesium containing pH raising agent to the produced water, whereby a precipitate comprising magnesium hydroxide is formed;
adding a source of carbonate ions to the produced water, whereby a carbonate containing precipitate is formed; and
removing the precipitate to provide a treated water.

18-19. (canceled)

20. A shale gas produced water which has been treated by the method of claim 1.

21. The use of a shale gas produced water which has been treated by the method of claim 1 as a drilling fluid.

22. The use of a shale gas produced water which has been treated by the method of claim 1 as a fracturing fluid.
